(19) United States
(12) Patent Application Publication
(10) Pub. No.: US 2026/0176455 A1
(43) Pub. Date: Jun. 25, 2026

(54) RESIN COMPOSITION AND MOLDED PRODUCT THEREFROM

(71) Applicants: Hyundai Motor Company, Seoul (KR); Kia Corporation, Seoul (KR); GS Caltex Corporation, Seoul (KR)

(72) Inventors: Sang Soo Jeon, Hwaseong (KR); Eun Chul Shin, Daejeon (KR)

(21) Appl. No.: 19/200,387

(22) Filed: May 6, 2025

(30) Foreign Application Priority Data
Dec. 24, 2024 (KR) 10-2024-0196351

(51) Int. Cl. C08L 23/12; C08K 3/016; C08K 7/14

(52) U.S. Cl. CPC C08L 23/12; C08K 3/016; C08K 7/14; C08K 2201/003; C08L 2201/02; C08L 2205/08; C08L 2207/20

(57) ABSTRACT

Provided is a resin composition including polyolefin resin, recycled polyolefin resin, a glass fiber, a flame retardant, and a compatibilizer, and a molded product therefrom. The composition may comprise 10-45 wt % polyolefin resin, 20-37 wt % recycled polyolefin resin, 10-40 wt % glass fiber, 10-40 wt % flame retardant, and 1.5-4.5 wt % compatibilizer. The polyolefin resin may have a melt flow index of about 10-100 g/10 min while the recycled resin may have about 10-40 g/10 min. A glycidyl methacrylate-grafted polyolefin copolymer may be included to enhance interface bonding. Non-halogen-based flame retardants help achieve UV04V-1 or better performance. The resulting composition exhibits tensile strength above 80 MPa, a flexural modulus above 7,000 MPa, and impact strength above 7.0 kJ/m².

### CROSS-REFERENCE TO RELATED APPLICATION

This application claims under 35 U.S.C. § 119(a) the benefit of Korean Patent Application No. 10-2024-0196351, filed in the Korean Intellectual Property Office on Dec. 24, 2024, the entire contents of which are incorporated herein by reference.

### BACKGROUND

### Technical Field

The present disclosure provides a resin composition, which includes recycled polyolefin resin to excellently reduce carbon and provides an excellent mechanical property and an excellent workability to a molded product made from the resin composition, and a molded product therefrom.

### Background

Issues related to environmental pollution resulting from wasted plastic have been raised, and social awareness of the environmental pollution resulting from wasted plastic has been expanded. Accordingly, regulations against the environmental pollution have been internationally expanded. As part of international regulations, carbon neutrality has been achieved, and carbon reduction measures have been implemented. For example, recycled plastic from wasted plastic, and biodegradable plastic, which is degradable, has been spotlighted.

Specifically, manners for recycling wasted plastic may be divided into three types of mechanical recycling (MR), chemical recycling (CR), and thermal recycling (TR). The mechanical recycling (MR) is to re-use the wasted plastic after preparing the wasted plastic to recycled plastic, through a physical process, and the chemical recycling (CR) is to degrade the wasted plastic through a chemical reaction and recycle each component of the wasted plastic.

For example, Korean Patent Registration No. 1383621 (Patent document 1) discloses a recycled polypropylene polymer composite material composition which includes polymer mixed resin including recycled polypropylene resin, talc, and nanoclay masterbatch, and anhydrous maleic acid graft polypropylene. However, the molded product made from the composition including the conventional mechanically-recycled plastic as in Patent document 1 is insufficient in a mechanical property or a chemical property such as flame retardancy. As an alternative to this problem, a manner for adding various additives has been suggested. However, when a large amount of additives is used to improve a physical property, the workability of the resin composition may become insufficient, or the effect of reducing carbon may be diminished.

Accordingly, research and development are required on a resin composition that effectively reduces carbon as wasted plastic is recycled, provides excellent workability to a composition including the wasted plastic, and offers excellent mechanical and chemical properties to the molded product made from the resin composition.

### SUMMARY

The present disclosure has been made to solve the above-mentioned problems occurring in the existing technologies while advantages achieved by the existing technologies are maintained intact.

An example embodiment of the present disclosure provides a resin composition, which includes wasted plastic to excellently reduce carbon and provides an excellent mechanical property and an excellent workability to a molded product made from the resin composition, and a molded product therefrom.

The technical problems to be solved by the present disclosure are not limited to the aforementioned problems, and any other technical problems not mentioned herein will be clearly understood from the following description by those skilled in the art to which the present disclosure pertains.

In one aspect, a resin composition is provided comprising: 1) a first polyolefin resin, 2) a second polyolefin resin, 3) a glass fiber, 4) a flame retardant, and 5) a compatibilizer. In aspects, suitably, the first and second polyolefin resins are different resins (e.g. differ in chemical structure such as different repeat units). In aspects, the first and second olefin resin may have one or more common repeat units.

Preferably, the second polyolefin resin is substantially composed of recycled resin. For example, in aspects, preferably at least 10, 20, 30, 40, 50, 60, 70, 80, 90, 95 or 100 weight percent of second polyolefin material is recycled.

According to an example embodiment of the present disclosure, there is provided a resin composition including polyolefn resin, recycled polyolefin resin, a glass fiber, a flame retardant, and a compatibilizer.

The polyolefin resin may have a melt flow index (MFI) which ranges about 10 g/10 min to 100 g/10 min when measured under conditions of 230° C. and a load of 2.16 kg.

The recycled polyolefin resin may include recycled polypropylene resin. The polypropylene resin may have a melt flow index (MFI) which ranges about 10 g/10 min to 40 g/10 min when measured under conditions of 230° C. and a load of 2.16 kg. The recycled polypropylene resin may have a density ranging from about 0.85 g/cm³ to 0.95 g/cm³.

The glass fiber may have an average diameter ranging from about 5 μm to 20 μm, and has an average length ranging from about 0.5 mm to 10 mm.

The flame retardant may be a non-halogen-based flame retardant. The non-halogen-based flame retardant may include at least one selected from the group consisting of a phosphate-based flame retardant and a metal oxide-based flame retardant. The compatibilizer may include an acrylate-based compatibilizer. The acrylate-based compatibilizer may include an epoxy group and has a melt flow index (MFI) which ranges about 2 g/10 min to 10 g/10 min when measured under conditions of 230° C. and a load of 2.16 kg. The acrylate-based compatibilizer may include a polyolefin copolymer grafted with glycidyl methacrylate.

The polyolefn resin may be in content ranging from 10 wt % to 45 wt %, The recycled polyolefn resin is in content ranging from about 20 wt % to 37 wt %, the glass fiber is in content ranging from about 10 wt % to 40 wt %, the flame retardant may be in content ranging from about 10 wt % to 40 wt %, and the compatibilizer may be in content ranging from about 1.5 wt % to 4.5 wt %.

According to an example embodiment of the present disclosure, there is provided a molded product made from the resin composition.

In some example embodiments, a resin composition is provided. The composition includes, based on 100 wt % of the resin composition: about 10 wt % to about 45 wt % of a polyolefn resin, about 20 wt % to about 37 wt % of a recycled polyolefn resin, about 10 wt % to about 40 wt % of a glass fiber, about 10 wt % to about 30 wt % of a flame retardant, and about 1.5 wt % to about 4.5 wt % of a compatibilizer.

The polyolefin resin may be a polymer of an α-olefin selected from the group consisting of ethylene, propylene, 1-butylene, 1-pentylene, 1-hexylene, 1-heptylene, and 1-octylene, and has a melt flow index (MFI) ranging from 10 g/10 min to 100 g/10 min when measured under conditions of 230° C. and a load of 2.16 kg. The recycled polypropylene resin may have a melt flow index (MFI) which ranges 10 g/10 min to 40 g/10 min when measured under conditions of 230° C. and a load of 2.16 kg.

The flame retardant may be a non-halogen-based flame retardant selected from the group consisting of phosphate-based flame retardants and metal oxide-based flame retardants.

The compatibilizer may be an acrylate-based compatibilizer comprising a polyolefin copolymer grafted with glycidyl methacrylate, having a melt flow index ranging from 2 g/10 min to 10 g/10 min when measured under conditions of 230° C. and a load of 2.16 kg.

In some example embodiments, a resin composition is provided. The resin composition includes, based on 100 wt % of the resin composition: about 10 wt % to about 45 wt % of a polyolefn resin, about 20 wt % to about 37 wt % of a recycled polyolefn resin, about 10 wt % to about 40 wt % of a glass fiber, about 10 wt % to about 30 wt % of a non-halogen-based flame retardant, and about 1.5 wt % to about 4.5 wt % of an acrylate-based compatibilizer. The polyolefin resin has a melt flow index (MFI) which ranges about 10 g/10 min to 100 g/10 min when measured under conditions of 230° C. and a load of 2.16 kg, the recycled polypropylene resin has a density ranging from about 0.85 g/cm³ to 0.95 g/cm³, and wherein the glass fiber has an average diameter ranging from about 5 μm to 20 μm. As discussed, the method and system suitably include use of a controller or processer.

In another embodiment, mobility such as vehicles is provided that comprise an apparatus as disclosed herein.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “recycled” herein refers to obtained from post-consumer or post-industrial plastic waste, reprocessed for reuse in new resin formulations.

The term “glass fiber” herein refers to a fibrous material consisting of thin strands of glass.

The term “non-halogen-based flame retardant” herein refers to any flame retardant free of halogen elements (e.g., chlorine, bromine).

The term “acrylate-based compatibilizer” herein refers to a polymeric agent containing acrylate or methacrylate functional groups.

### Resin Composition

According to the present disclosure, resin composition includes a first polyolefin resin, a second polyolefin resin, a glass fiber, a flame retardant or a compatibilizer.

### First Polyolefin Resin

A first polyolefin resin improves a mechanical property, such as tensile strength and impact strength, of a molded product made from the resin composition.

In addition, the first polyolefin resin, which is a polymer of olefin, may be, for example, a polymer of α-olefin. Specifically, the first polyolefin resin may include a polymer of α-olefin including at least one selected from the group consisting of ethylene, propylene, 1-butylene, 1-pentylene, 1-hexylene, 1-heptylene, and 1-octylene. More specifically, the first polyolefin resin may include polypropylene. For example, the polyolefin resin may be a polypropylene, which is a propylene homopolymer.

A first polyolefin resin may have a melt flow index (MFI) which ranges 10 g/10 min to 100 g/10 min when measured under conditions of 230° C. and a load of 2.16 kg. Specifically, the first polyolefin resin may have a melt flow index (MFI) of at least 20 g/10 min, at least 30 g/10 min, at least 45 g/10 min, or at most 90 g/10 min, at most 80 g/10 min, or at most 70 g/10 min when measured under conditions of 230° C. and a load of 2.16 kg. The MFI of the first polyolefin resin is in the above range, may improve the mechanical property, such as the tensile strength and the impact strength, of the molded product made.

In addition, the first polyolefin resin may be included in content ranging from 10 wt % to 45 wt %, based on 100 wt % of the resin composition. Specifically, the first polyolefin resin may be included in content of at least 12 wt %, at least 15 wt %, at most 40 wt %, at most 35 wt %, or at most 30 wt %, based on 100 wt % of the resin composition. The content of the first polyolefin resin, which is in the above range, may prevent the mechanical property such as the tensile strength and the impact strength of the molded product from being insufficient, may prevent the chemical property, such as the flame retardancy, of the molded product from being insufficient, or may prevent the effect of reducing carbon from being degraded, due to the use of the recycled polyolefin resin.

### A Second Polyolefin Resin

A second polyolefin resin, which is derived from wasted plastic, improves the effect of reducing carbon in the molded product made to provide eco-friendliness.

The second polyolefin resin may include a recycled polyolefin resin, specifically, at least 70 weight percent.

In addition, the recycled polyolefin resin may be a material derived from wasted plastic, especially, including a propylene homopolymer. For example, the recycled polyolefin resin may include various polymer components such as polyethylene, in addition to polypropylene depending on the source of the waste plastic. If necessary, the recycled polyolefin resin may include a smaller amount of inorganic metal, or metals. In addition, the recycled polyolefin resin may be, by a heat history, discolored or colored when compared to new polyolefin resin.

In addition, the recycled polyolefin resin, which is a polymer of olefin, may be, for example, a polymer of α-olefin. Specifically, the recycled polyolefin resin may include a polymer of α-olefin including at least one selected from the group consisting of ethylene, propylene, 1-butylene, 1-pentylene, 1-hexylene, 1-heptylene, and 1-octylene. More specifically, the recycled polyolefin resin may include recycled polypropylene resin. For example, the recycled polyolefin resin may include recycled polypropylene which is propylene homopolymer.

In addition, the second polyolefin resin may have a melt flow index (MFD which ranges 10 g/10 min to 40 g/10 min when measured under conditions of 230° C. and a load of 2.16 kg. Specifically, the second polyolefin resin may have a melt flow index (MD of at least 15 g/10 min, at least 18 g/10 min, at least 20 g/10 min, or at most 35 g/10 min, at most 30 g/10 min, or at most 28 g/10 min when measured under conditions of 230° C. and a load of 2.16 kg. The MFI of the second polyolefin resin, which is in the above range, may improve the mechanical property such as the tensile strength and the impact strength of the molded product made.

The second polyolefin resin may have the density ranging from 0.85 g/cm³ to 0.95 g/cm³. Specifically, the second polyolefin resin may have the density of at least 0.87 g/cm³, at least 0.88 g/cm³, at least 0.90 g/cm³, at most 0.93 g/cm³, or at most 0.92 g/cm³. The density of the second polyolefin resin, which is in the above range, may prevent the molded product from being degraded in the mechanical property, such as tensile strength and impact strength and the chemical property such as flame retardancy and thermal stability.

In addition, the second polyolefin resin may be included in content ranging from 20 wt % to 37 wt %, based on 100 wt % of the resin composition. Specifically, the second polyolefin resin may be included in content of at least 22 wt %, at least 25 wt %, at least 28 wt %, or at most 35 wt %, at most 33 wt %, or at most 31 wt %, based on 100 wt % of the resin composition. The content of the second polyolefin resin, which is in the above range, may improve the effect of reducing carbon in the molded product, and may prevent the mechanical property, such as the tensile strength and the impact strength, of the molded product made from being insufficient, or may prevent the chemical property, such as the flame retardancy, of the molded product made from being insufficient.

### Glass Fiber

The glass fiber may improve the mechanical property, such as strength, of the molded product.

In addition, the glass fiber may have an average diameter ranging from 5 μm to 20 μm. Specifically, the average diameter of the glass fiber may be at least 8 μm, at least 10 μm, at least 12 μm, at most 18 μm, or at most 15 μm. The average diameter of the glass fiber, which is in the above range, may prevent the difference in physical property inside the molded product, or the degradation of the workability of the composition, which is made as the dispersibility of the glass fiber is degraded, and may prevent the mechanical property, such as tensile strength or impact strength, of the molded product from being degraded. In this case, the average diameter may be a value corresponding to a 50% point (D₅₀) in a cumulative distribution of the particle sizes measured through a Particle size analyzer (PSA), but the present disclosure is not limited thereto.

The glass fiber may have an average length ranging from 0.5 mm to 10 mm. Specifically, the glass fiber may have an average length of at least 1 mm, at least 1.5 mm, at least 2 mm, at most 8 mm, or at most 5 mm. The average diameter of the glass fiber, which is in the above range, may prevent the difference in physical property inside the molded product, or the degradation of the workability of the composition, and the degradation of the mechanical property, such as tensile strength or impact strength, of the molded product, which are made as the dispersibility of the glass fiber is degraded.

In addition, the glass fiber may be included in content ranging from 10 wt % to 40 wt %, based on 100 wt % of the resin composition. Specifically, the glass fiber may be included in content of at least 20 wt %, at least 25 wt %, at least 28 wt %, at most 38 wt %, at most 35 wt %, or at most 33 wt %, based on 100 wt % of the resin composition. The content of the glass fiber, which is in the above range, may improve the effect of reducing carbon in the molded product made, may prevent the mechanical property, such as the tensile strength and the impact strength, of the molded product from being insufficient, and may prevent the chemical property, such as the flame retardancy, of the molded product from being insufficient.

### Flame Retardant

The flame retardant improves the flame retardancy of the molded product.

In addition, the flame retardant may be a non-halogen-based flame retardant. Specifically, the flame retardant may include at least one selected from the group consisting of a phosphate-based flame retardant and a metal oxide-based flame retardant.

The phosphate-based flame retardant may be, for example, triphenyl phosphate, trimethyl phosphate, triethyl phosphate, bisphenol diphenyl phosphate, ammonium polyphosphate, melamine polyphosphate, melamine pyrophosphate, melamine ammonium phosphate, piperazine polyphosphate, xyleneyl diphenyl phosphate, or a combination thereof, but the present disclosure is not limited thereto.

The metal oxide-based flame retardant may include, for example, at least one metal oxide selected from the group consisting of magnesium oxide, zinc oxide, and aluminum oxide.

In addition, the flame retardant may be included in content ranging from 10 wt % to 40 wt %, based on 100 wt % of the resin composition. Specifically, the flame retardant may be included in content of at least 13 wt %, at least 15 wt %, at least 18 wt %, at most 35 wt %, at most 30 wt %, or at most 25 wt %, based on 100 wt % of the resin composition. The content of the flame retardant, which is in the above range, may prevent the chemical property, such as flame retardancy, of the molded product from being insufficient or may prevent the workability of the composition from being insufficient.

### Compatibilizer

The compatibilizer improves compatibility between components in the composition to improve strength of the molded product and minimizes the degradation of the mechanical property of the molded product, as the recycled polyolefin resin is contained.

In addition, the compatibilizer may include various materials without a special limitation, as long as the materials are commonly purchased and/or prepared. For example, the compatibilizer may include an acrylate-based compatibilizer.

The acrylate-based compatibilizer may include, for example, an epoxy group. Specifically, the acrylate-based compatibilizer may include a polyolefin copolymer grafted with glycidyl methacrylate. Specifically, the polyolefin copolymer may include a polymer of α-olefin. For example, the polyolefin copolymer may include the polymer of α-olefin including at least one selected from the group consisting of ethylene, propylene, 1-butylene, 1-pentylene, 1-hexylene, 1-heptylene, and 1-octylene. More specifically, the acrylate-based compatibilizer may include polyethylene grafted with glycidyl methacrylate. The graft ratio of the graft copolymer may be at least 1 wt %, at least 2 wt %, at most 10 wt %, at most 8 wt %, or at most 4 wt %, based on 100 wt % of the copolymer.

The acrylate-based compatibilizer may have a melt flow index (MFI) which ranges 2 g/10 min to 10 g/10 min when measured under conditions of 230° C. and a load of 2.16 kg. Specifically, the acrylate-based compatibilizer may have a melt flow index (MFI) of at least 3 g/10 min, at least 4 g/10 min, at most 8 g/10 min, at most 7 g/10 min, or at most 6 g/10 min when measured under conditions of 230° C. and a load of 2.16 kg. The MFI of the acrylate-based compatibilizer, which is in the above range, may improve the mechanical property such as the tensile strength and the impact strength of the molded product made, and may improve the compatibilizer between components in the composition to improve workability.

In addition, the acrylate-based compatibilizer may be included in content ranging from 1.5 wt % to 4.5 wt %, based on 100 wt % of the resin composition. Specifically, the acrylate-based compatibilizer may be included in content of at least 1.8 wt %, at least 2 wt %, at most 4.3 wt %, or at most 4.0 wt %, based on 100 wt % of the resin composition. The content of the acrylate-based compatibilizer, which is in the above range, may prevent workability from being insufficient, the chemical property, such as flame retardancy, from being insufficient, or an unpleasant odor from the composition, which is made as the compatibilizer between the components inside the composition is degraded.

As described above, the resin composition includes the recycled polyolefin resin, which is obtained by recycling the wasted plastic, to excellently reduce carbon and to exhibit excellent workability such as injection moldability.

### Molded Product

According to the present disclosure, the molded product is molded from the resin composition as described above. In this case, the molding manner may include various manners without a special limitation, as long as the manners are applicable to rubber or plastic molding. For example, the molding manner may employ an extrusion molding manner after mixing using an open mill roll, an internal mixer, or a kneader, but the present disclosure is not limited thereto.

The molded product may be a material, and specifically, may be a material for mobility. More specifically, the molded product may be a part for mobility and a part for a battery module assembly housing.

In this case, the mobility may include, for example, a vehicle, an aircraft, a train, a ship, or various mobile robots.

In addition, the molded product may have tensile strength of at least 70 MPa, at least 75 MPa, at least 78 MPa, at least 80 MPa, at most 95 MPa, at most 90 MPa, or at most 88 MPa, as measured in compliance with ISO 527.

The molded product may have impact strength of at least 7.0 KJ/m², at least 7.4 KJ/m², at least 7.5 KJ/m², at most 9.0 KJ/m², at most 8.8 KJ/m², or at most 8.5 KJ/m², as measured in compliance with ISO 180.

The molded product including the recycled polyolefin resin obtained by recycling the wasted plastic exhibits an excellent mechanical property, such as tensile strength, or impact strength, and an excellent chemical property, such as flame retardancy. Accordingly, the molded product is significantly appropriate as a material for various fields, such as a vehicle part applied to an environment requiring flame retardancy.

Hereinafter, the present disclosure will be described in detail through embodiments. However, these embodiments are provided only for the illustrative purpose, and the scope of the present disclosure is not limited to the embodiments even in any meaning.

### Embodiment

### Examples 1 and 2, and Comparative Examples 1 to 6 Preparation of Composition

Components were mixed with compositions shown in following Table 1 to prepare a resin composition.

TABLE 1

| | | | Comparative | Comparative | Comparative | Comparative | Comparative | Comparative |
|---|---|---|---|---|---|---|---|---|
| (wt %) | Example 1 | Example 2 | Example 1 | Example 2 | Example 3 | Example 4 | Example 5 | Example 6 |
| Polyolefin | 18 | 16 | 50 | 20 | 19 | 15 | 8 | — |
| resin (A) | | | | | | | | |
| Recycled | 30 | 30 | — | 30 | 30 | 30 | 40 | 40 |
| polyolefin | | | | | | | | |
| resin (B) | | | | | | | | |
| Glass fiber (C) | 30 | 30 | 30 | 30 | 30 | 30 | 30 | 30 |
| Non-halogen- | 20 | 20 | 20 | 20 | 20 | 20 | 20 | 28 |
| based flame | | | | | | | | |
| retardant (D) | | | | | | | | |
| Acrylate- | 2 | 4 | — | — | 1 | 5 | 2 | 2 |
| based | | | | | | | | |
| compatibilizer | | | | | | | | |
| (E) | | | | | | | | |

Physical properties, manufacturers, and product names of components used in Comparative Examples and Examples are shown in Table 2.

TABLE 2

| | Physical property, manufacturer, and product name |
|---|---|
| Polyolefin resin (A) | MFI measured under conditions of 230° C. and a load of 2.16 kg. 60 |
| | g/10 min |
| Recycled polyolefin resin (B) | MFI measured under conditions of 230° C. and a load of 2.16 kg. 25 |
| | g/10 min, density: 0.91 g/cm³ |
| Glass fiber (C) | Cylinder-type glass fiber [average diameter (D₅₀): 13 μm, average |
| | length: 3 mm] |
| Non-halogen-based flame | Manufacturer: ADKEA, product name: ADKSTAB FP2500S |
| retardant (D) | |
| Acrylate-based compatibilizer | polyethylene copolymer grafted with glycidyl methacrylate. |
| (E) | (MFI measured under conditions of 230° C. and a load of 2.16 kg. 5 |
| | g/10 min) |

### Test Example: Measurement of Physical Properties of Compositions and Molded Product

The physical properties of the compositions according to the Examples and the Comparative Examples and the molded product made from the compositions were measured in the following manner, and the results are shown in Table 3.

### (1) Density

A molded product was prepared through a test manner complying with ISO 1193 and the density of the molded product was measured.

### (2) Tensile Strength

A molded product was prepared through a test manner complying with ISO 527 and the tensile strength of the molded product was measured.

### (3) Modulus of Flexural Elasticity

A molded product was prepared through a test manner complying with ISO 178 and the modulus of flexural elasticity of the molded product was measured.

### (4) Impact Strength

A molded product was prepared through a test manner complying with ISO 180 and the impact strength of the molded product was measured.

### (5) Flame Retardancy

A sample having a thickness of 1.5 mm was prepared and the flame retardancy of the sample was measured, based on the UL 94 vertical flame retardancy test.

TABLE 3

| | | | Modulus of | | |
|---|---|---|---|---|---|
| | | Tensile | flexural | Impact | |
| | Density | strength | elasticity | strength | Flame |
| | (g/cm³) | (MPa) | (MPa) | (KJ/m²) | retardancy |
| Example 1 | 1.28 | 85 | 7,300 | 7.7 | V-0 |
| Example 2 | 1.28 | 83 | 7,100 | 8.2 | V-0 |
| Comparative | 1.27 | 88 | 7,800 | 8.1 | V-0 |
| Example 1 | | | | | |
| Comparative | 1.29 | 79 | 6,800 | 7.2 | V-2 |
| Example 2 | | | | | |
| Comparative | 1.29 | 82 | 7,000 | 7.2 | V-2 |
| Example 3 | | | | | |
| Comparative | 1.28 | 80 | 6,700 | 8.3 | V-2 |
| Example 4 | | | | | |
| Comparative | 1.28 | 76 | 6,000 | 6.9 | Indeterminate |
| Example 5 | | | | | |
| Comparative | 1.34 | 74 | 6,700 | 7.3 | V-1 |
| Example 6 | | | | | |

As shown in Table 3, it may be recognized that Examples 1 and 2 were significantly appropriate as materials for various fields requiring excellent flame retardancy and the excellent mechanical property, as the molded products according to Examples 1 and 2 exhibited an appropriate density, an excellent mechanical property, such as tensile strength, modulus of flexural elasticity, and impact strength, and excellent flame retardancy, when compared to Comparative Example 1 including recycled polyolefin resin.

To the contrary, Comparative Example 2 not including the acrylate-based compatibilizer exhibited insufficient tensile strength and insufficient flame retardancy. In addition, Comparative Example 3 including a smaller amount of acrylate-based compatibilizer and Comparative Example 4 including a large amount of acrylate-based compatibilizer exhibited insufficient flame retardancy. In particular, Examples 1 and 2 exhibited the excellent flame retardancy, when compared to Comparative Examples 2 to 4. The flame retardancy was determined as being excellent, based on that the acrylate-based compatibilizer improved the compatibility between components in the composition to improve the mechanical strength of the molded product and contributed to complementing the structural stability of a char (carbide) layer produced by the flame retardant when a fire occurred.

Furthermore, Comparative Examples 5 and 6 including an excess amount of recycled polyolefn resin were insufficient in the tensile strength, the modulus of flexural elasticity, and the impact strength, and insufficient in flame retardancy. In particular, in Comparative Example 5, as the sample was completely burned, the measurement of a flame-retardant grade was failed.

As described above, according to the present disclosure, the resin composition includes the recycled polyolefin resin, which is obtained by recycling the wasted plastic, to excellently reduce carbon and to exhibit excellent workability such as injection moldability.

In addition, the molded product made from the resin composition exhibits an excellent mechanical property, such as tensile strength, or impact strength, and a chemical property, such as flame retardancy. Accordingly, the molded product is remarkably appropriate as a material for various fields, such as a vehicle part applied to an environment requiring flame retardancy.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A resin composition comprising:
a first polyolefin resin, a second polyolefin resin, a glass fiber, a flame retardant, and a compatibilizer.

2. The resin composition of claim 1 wherein at least 70 weight percent of the second polyethene resin is a recycled.

3. The resin composition of claim 1, wherein the first polyolefin resin has a melt flow index (MFI) which ranges about 10 g/10 min to 100 g/10 min when measured under conditions of 230° C. and a load of 2.16 kg.

4. The resin composition of claim 2, wherein the recycled second polyolefin resin comprises recycled polypropylene resin.

5. The resin composition of claim 4, wherein the polypropylene resin has a melt flow index (MFI) which ranges about 10 g/10 min to 40 g/10 min when measured under conditions of 230° C. and a load of 2.16 kg.

6. The resin composition of claim 4, wherein the recycled second polypropylene resin has a density ranging from about 0.85 g/cm³ to 0.95 g/cm³.

7. The resin composition of claim 1, wherein the glass fiber has an average diameter ranging from about 5 μm to 20 μm, and has an average length ranging from about 0.5 mm to 10 mm.

8. The resin composition of claim 1, wherein the flame retardant is a non-halogen-based flame retardant.

9. The resin composition of claim 8, wherein the non-halogen-based flame retardant comprises at least one selected from the group consisting of a phosphate-based flame retardant and a metal oxide-based flame retardant.

10. The resin composition of claim 1, wherein the compatibilizer comprises an acrylate-based compatibilizer.

11. The resin composition of claim 10, wherein the acrylate-based compatibilizer comprises an epoxy group, and has a melt flow index (MFI) which ranges about 2 g/10 min to 10 g/10 min when measured under conditions of 230° C. and a load of 2.16 kg.

12. The resin composition of claim 11, wherein the acrylate-based compatibilizer comprises a polyolefin copolymer grafted with glycidyl methacrylate.

13. The resin composition of claim 1, wherein the first polyolefin resin is in content ranging from 10 wt % to 45 wt %,
wherein the second polyolefin resin is in content ranging from about 20 wt % to 37 wt %,
wherein the glass fiber is in content ranging from about 10 wt % to 40 wt %,
wherein the flame retardant is in content ranging from about 10 wt % to 40 wt %, and
wherein the compatibilizer is in content ranging from about 1.5 wt % to 4.5 wt %.

14. A molded product molded from the resin composition according to claim 1.

15. The molded product of claim 14, wherein the molded product is a material for mobility.

16. A resin composition comprising, based on 100 wt % of the resin composition:
about 10 wt % to about 45 wt % of a first polyolefin resin,
about 20 wt % to about 37 wt % of a recycled second polyolefin resin,
about 10 wt % to about 40 wt % of a glass fiber,
about 10 wt % to about 40 wt % of a flame retardant, and
about 1.5 wt % to about 4.5 wt % of a compatibilizer.

17. The resin composition of claim 16, wherein the first polyolefin resin is a polymer of an α-olefin selected from the group consisting of ethylene, propylene, 1-butylene, 1-pentylene, 1-hexylene, 1-heptylene, and 1-octylene, and has a melt flow index (MI) ranging from 10 g/10 min to 100 g/10 min when measured under conditions of 230° C. and a load of 2.16 kg.

18. The resin composition of claim 16, wherein the recycled second polypropylene resin has a melt flow index (MI) which ranges 10 g/10 min to 40 g/10 min when measured under conditions of 230° C. and a load of 2.16 kg.

19. The resin composition of claim 1, wherein the flame retardant is a non-halogen-based flame retardant selected from the group consisting of phosphate-based flame retardants and metal oxide-based flame retardants.

20. A resin composition comprising, based on 100 wt % of the resin composition:
about 10 wt % to about 45 wt % of a first polyolefin resin,
about 20 wt % to about 37 wt % of a recycled second polyolefin resin,
about 10 wt % to about 40 wt % of a glass fiber,
about 10 wt % to about 40 wt % of a non-halogen-based flame retardant, and
about 1.5 wt % to about 4.5 wt % of an acrylate-based compatibilizer,
wherein the polyolefin resin has a melt flow index (MFI) which ranges about 10 g/10 min to 100 g/10 min when measured under conditions of 230° C. and a load of 2.16 kg,
the recycled second polypropylene resin has a density ranging from about 0.85 g/cm³ to 0.95 g/cm³, and
wherein the glass fiber has an average diameter ranging from about 5 μm to 20 μm.
